(19) United States
(12) Patent Application Publication
(10) Pub. No.: US 2014/0254201 A1
(43) Pub. Date: Sep. 11, 2014

(54) POWER SUPPLY FOR PROLONGING HOLD-UP TIME

(71) Applicant: ZIPPY TECHNOLOGY CORP., New Taipei City (TW)

(72) Inventors: Tsun-Te SHIH, New Taipei City (TW); Yu-Yuan CHANG, New Taipei City (TW); Tien -Wei CHANG, New Taipei City (TW)

(73) Assignee: ZIPPY TECHNOLOGY CORP., New Taipei City (TW)

(21) Appl. No.: 13/788,765

(22) Filed: Mar. 7, 2013

(51) Int. Cl. H02M 3/22

(52) U.S. Cl. CPC H02M 3/22
USPC 363/15

(57) ABSTRACT

A power supply for prolonging a hold-up time includes a main power supply system, and a hold-up power supply system connected in parallel to a power factor correction unit in the main power supply system. The hold-up power supply system includes an isolation transformer element connected to the power factor correction unit for receiving and transforming a first power to a third power, a power storage element for receiving the third power and storing as a hold-up power, and a power comparison unit connected between the power factor correction unit and the power storage element. The power comparison unit compares a second power generated from phase modulation performed by the power factor correction unit and the hold-up power, and outputs the hold-up power when the second power is smaller than the hold-up power, so as to sustain the power modulation unit to continue operating for a hold-up time.

### FIELD OF THE INVENTION

The present invention relates to a power supply for prolonging a hold-up time, and particularly to a power supply for prolonging a hold-up time that sustains the power supply to continue operating for a hold-up time using a hold-up power.

### BACKGROUND OF THE INVENTION

In order to sustain in supplying power for a period time in the event of an external power interrupt and to allow a load to complete necessary storage and control operations for a safe shut-down, a current alternating-current (AC) power supply provides a delayed operation period, also referred to as a hold-up time. However, as a power density of a power supply gets higher, efficiency and requirements for preventing abnormal powering are also increased. Thus, a longer period of the above hold-up time is also demanded to prolong a sustaining power period.

A common power supply generally includes a rectifier, a power factor corrector, a voltage stabilizer and a power modulator. At an initial stage of booting, the rectifier converts an external power to a DC power. The power factor corrector modulates a phase of the DC power, and outputs a power that charges the voltage stabilizer. The power supply needs to wait until the voltage stabilizer operates in a stable state before it can be normally driven. That is to say, only when the voltage stabilizer is fully charged, the power can then be modulated and outputted. The foregoing hold-up time refers to the time when the power supply is incapable of obtaining the external power, the power factor corrector stops converting the power and the voltage stabilizer becomes discharged. There are two common approaches for prolonging the hold-up time. A first approach is to increase a storage capacity of the voltage stabilizer, and a second approach is to additionally provide an auxiliary power storage element. However, the increasing of the storage capacity implies a lengthened charging time of the storage element, such that a boot time of the power supply is also increased. On the other hand, by enlarging a boot current for shortening the boot time, components of the power supply may not be apt to withstand such great boot current. The Taiwan Patent Publication 1364651 discloses embodiments of an additionally provided auxiliary power storage element. In the above publication, hold-up power is stored by an auxiliary power storage element, which provides the hold-up power for prolonging the hold-up time in the event of an abnormal external power. Nevertheless, as the auxiliary power storage element is directly connected in parallel with the storage element, meaning that an equivalent load of the power supply is virtually increased to disfavor an overall powering performance of the power supply.

### SUMMARY OF THE INVENTION

Therefore the primary object of the present invention is to overcome issues of a slow booting process and an increased load upon a main power supply system, which are derived from an intention of prolonging a hold-up time in a conventional power supply architecture and approach.

To achieve the above object, a power supply for prolonging a hold-up time is provided. The power supply comprises a main power supply system and a hold-up time powering system. The main power supply system comprises a rectification unit for receiving and rectifying an external power to output a first power, a power factor correction unit for receiving the first power and modulating a phase of the first power to generate a second power, a voltage stabilization element for receiving and stabilizing the second power, and a power modulation unit, connected to the voltage stabilization element for converting the second power to output an operating power. Further, the power factor correction unit has an input end connected to the rectification unit, and an output end connected to the voltage stabilization element. The hold-up power system, connected in parallel to the power factor correction unit, comprises an isolation transformer element connected to the input end of the power factor correction unit for transforming the first power to a third power, a power storage element for receiving the third power and storing as a hold-up power, and a power comparison unit disposed between the output end of the power factor correction unit and the power storage element for obtaining the second power and the hold-up power. The power comparison unit comprises a first status, a second status and a third status. Wherein, the first status renders the power storage element be continuously charged when the second power is greater than the hold-up power, the second status renders the power storage element to be no longer charged when the second power is equal to the hold-up power, and the third status prompts the power storage element to output the hold-up power to the power modulation unit to continue converting the operating power for a hold-up time when the second power is smaller than the hold-up power.

In an embodiment, the hold-up power supply system comprises a charging control unit for controlling a conduction status of the isolation transformer element. Further, the charging control unit comprises a power switch element, and a driving control unit for controlling a conduction status of the power switch element.

In an embodiment, the hold-up power supply system comprises a one-directional conduction element. The one-directional conduction element is connected between the isolation transformer element and the power storage element, and limits a current direction for conducting the power storage element. Further, the one-directional conduction element is a diode.

In an embodiment, the power storage element is a group selected from a battery element or a capacitor.

In an embodiment, the power comparison unit is a diode:

Compared to the prior art, the power supply for prolonging a hold-up time disclosed by the present invention features the advantages below.

First of all, a load of the main power supply system is kept unaffected. In the present invention, the power storage element is not connected in parallel to the voltage stabilization element, and the power storage element is charged using the third power induced by magnetic coupling of the isolation transformer element. Compared to the prior art of directly charging the power storage element with the second power, the equivalent load of the main power supply system in operation of the present invention is substantially kept unaffected.

Secondly, the power storage process is performed by a current of a smaller power. In the present invention, the power storage element is charged by the third power having a smaller current value. Therefore, not only the overall operation of the power supply is not influenced but also the load of the main power supply system is not further burdened.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a power supply for prolonging a hold-up time according to an embodiment of the present invention.

FIG. 2 is a schematic diagram of a power supply for prolonging a hold-up time according to an embodiment of the present invention.

### DETAILED DESCRIPTION OF THE PREFERRED EMBODIMENTS

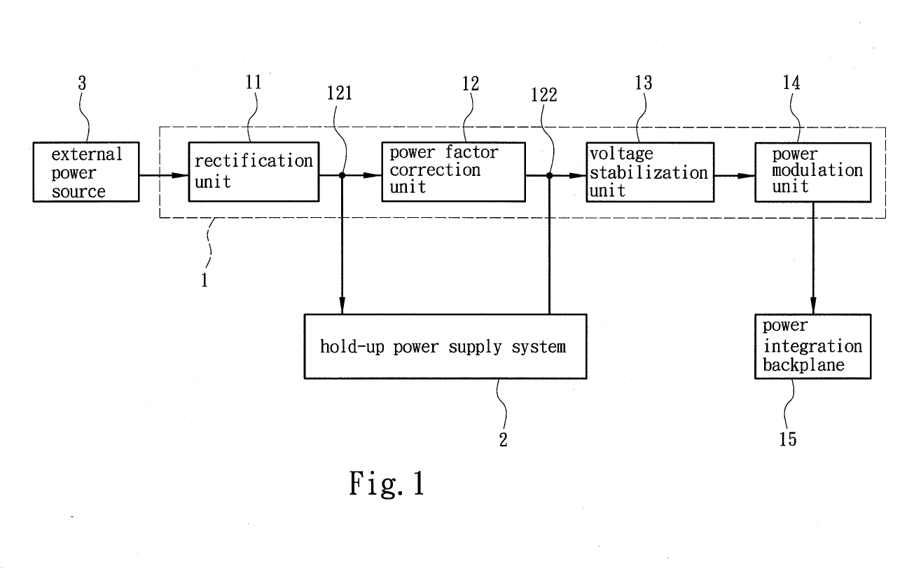

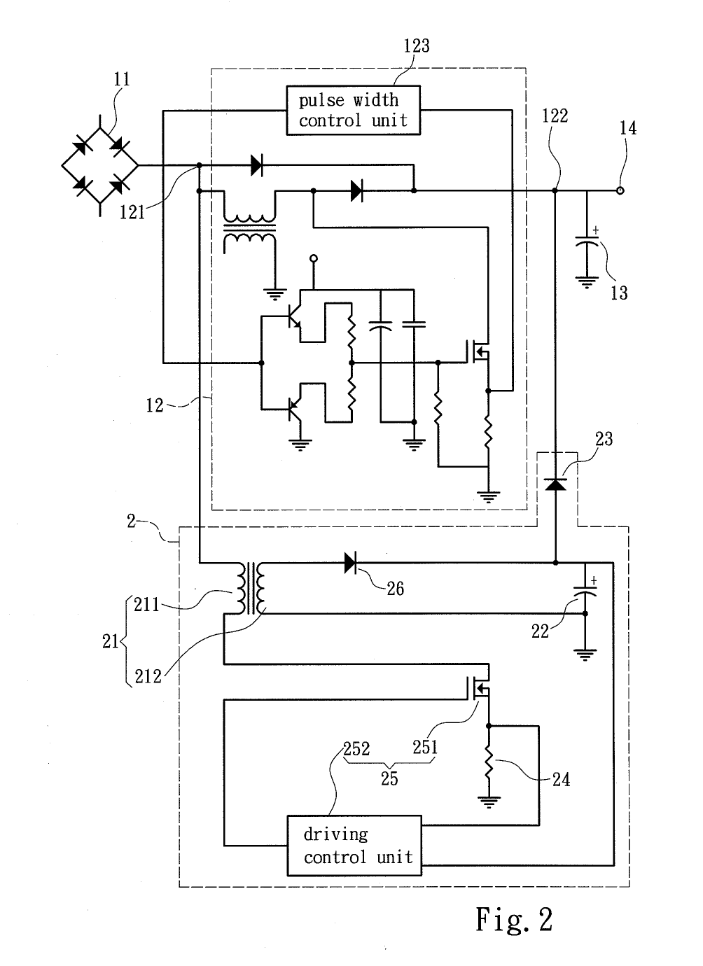

Referring to FIG. 1 and FIG. 2, when an external power cannot be acquired in the event of a sudden power interrupt or an unexpected blackout while being powered by the external power, a power supply for prolonging a hold-up time according to an embodiment of the present invention is capable of sustaining a hold-time of the power supply. Thus, issues of data loss or damages in elements of an information processing apparatus connected to the power supply can be prevented. According to an embodiment of the present invention, a power system comprises a main power supply system 1 and a hold-up power supply system 2. The main power supply system 1 comprises a rectification unit 11, a power factor correction unit 12 connected to the rectification unit 11, a voltage stabilization element 13, and a power modulation unit 14 connected to the voltage stabilization element 13. The rectification unit 11 is connected to an external power source 3, and receives and rectifies the external power to output a first power. The power factor correction unit 12 receives the first power, adjusts phases of the current and voltage of the first power such that a power factor of the first power satisfies a predetermined requirement, and converts the phase-adjusted first power to output a second power. More specifically, the power factor correction unit 12 has an input end 121 connected to the rectification unit 11, and an output end 122 connected to the voltage stabilization element 13. The voltage stabilization element 13 receives and stores the second power from the output end 122 of the power factor correction unit 12, and generates a stabilized voltage when having become stable. The power modulation unit 14 is connected to the voltage stabilization element 13, and converts the second power to output an operating power. Further, when the power supply of the present invention is implemented to an N+M backup power system, the main power supply system 1 further comprises a power integration backplane 15 connected subsequent to the power modulation unit 14. The power integration backplane 15 integrates the operating power to the information processing apparatus. Wherein, N represents the number of power supplies by the backup power system for driving a total power load operated by the information processing apparatus, and M represents the tolerable number of damaged power supplies. Further, the power factor correction unit 12 comprises a pulse width control unit 123 for controlling operations of the power factor correction unit 12.

The hold-up power supply system 2 is connected in parallel to the power factor correction unit 12. More specifically, the hold-up power supply system 2 comprises an isolation transformer element 21 connected to the input end 121, a power storage element 22 connected to the isolation transformer element 21, and a power comparison unit 23 disposed between the output end 122 and the power storage element 21. The isolation transformer element 21 has a primary coil 211, and a secondary coil 212 that magnetically couples with the primary coil 211. Further, the isolation transformer element 21 is coupled to the input end 121 of the power factor correction unit 12 via the primary coil 211, and is connected to the power storage element 22 via the secondary coil 212. After receiving the first power, the isolation transformer element 21 outputs a third power from the magnetic coupling of the primary coil 211 and the secondary coil 213. Further, the number of turns of the primary coil 211 may be smaller than that of the secondary coil 212. That is to say, a power potential of the third power generated after transformation performed by the isolation transformer element 21 is higher than a potential of the first power. The power storage element 22 receives and stores the third power from the secondary coil 212 and thus contains a hold-up power. The power storage element 22 may be a group selected from a battery element or a capacitor. Further, the isolation transformer element 21 is connected to a current limiting resistor 24. When the first power is outputted to the output end 121, the current of the first power is divided due to the resistance in the current limiting resistor 24 and the equivalent resistance of the power factor correction unit 12, the voltage stabilization element 13 and the power modulation unit 14. The current limiting resistor 24 maintains the current received by the hold-up power supply system 2 to be smaller than the current received by the power factor correction unit 12. That is to say, the hold-up power supply system 2 of the present invention is charged by a smaller power for reducing an operation load of the main power supply system 1. Further, the current received by the power factor correction unit 12 is several times of the current received by the hold-up power supply system 2, e.g., preferably ten times. The hold-up power supply system 2 further comprises a charging control unit 25 connected to the isolation transformer element 21. The charging control unit 25 controls a conduction status of the isolation transformer element 21. More specifically, the charging control unit 25 comprises a power switch element 251, and a driving control unit 252 for controlling a conduction status of the power switch element 251. The power switch element 251 may be a group selected from a bipolar junction transistor (BJT), a metal-oxide semiconductor field-effect transistor (MOSFET) or an insulated gate bipolar transistor (IGBT). The driving control unit 252 may determine the conduction of the power switch element 251 through feedback control or timing control. As implementation methods of the driving control unit 252 are quite diversified, details thereof are not limited by the embodiment of the present invention. The driving control unit 252 drives and turns on the power switch element 251, and the isolation transformer element 21 performs power transformation to output the third power for charging the power storage element 22. Further, the hold-up power supply system 2 comprises a one-directional conduction element 26 connected between the isolation transformer element 21 and the power storage element 22. The one-directional conduction element 26 may be a diode, and restrains the current of the hold-up power supply system 2 from flowing towards the isolation transformer element 21. That is to say, the one-directional conduction element 26 limits the current of the third power to conduct towards only the power storage element 22.

In continuation, details of the power comparison unit 23 applied to the power supply according to an embodiment of the present invention are described below. The power comparison unit 23 has a first status, a second status and a third status. The first status of the power comparison unit 23 renders the power storage element 22 to be continuously charged when the second power is greater than the hold-up power. The second status of the power comparison unit 23 renders the power storage element 22 to be no longer charged when the second power is equal to the hold-up power. The third status of the power comparison unit 23 prompts the power storage element 22 to output the hold-up power to the power modulation unit 14 when the second power is smaller than the hold-up power. More specifically, at an initial phase of converting the external power received by the main power supply system 1, the power storage element 22 at this point is not stored with any power. In other words, the power storage element 22 does not contain the hold-up power when the power supply is initially powered on. By converting the external power using the rectification unit 11 to output the first power, the first power is outputted to the power factor correction unit 12 for phase modulation, and is also outputted to the isolation transformer element 21. As the isolation transformer element 21 receives the first power, the isolation transformer element 21 converts the first power via the primary coil 211 and the secondary coil 212 to output the third power to the power storage element 22. The power storage element 22 receives the third power and becomes charged, with however the stored power still being smaller than the second power. The power comparison unit 23 at this point is in the first status. After charging the power storage element 22 for a period of time, the power potential of the hold-up power rises to equal to the second power, and the power comparison unit 23 changes to the second status, such that the charging process stops while the power potential of the hold-up power is still maintained. In the event that the main power supply system 1 is incapable of normally obtaining the external power, the power potential of the second power is affected and gradually lowers. When the power potential of the second power is lowered to the hold-up power, the power comparison unit 23 enters the third status, and the power storage element 22 outputs the hold-up power to keep powering the power modulation unit 14 to continue operating for the hold-up time. Thus, a user is allowed to perform operations such as file saving on the information processing apparatus or shutting down the information processing apparatus within the hold-up time. Further, the length of the hold-up time is determined by the amount of the power storage in the power storage element 22.

In conclusion, in the power supply for prolonging a hold-up time, a hold-up power supply system is connected in parallel to a power factor correction unit in a main power supply system. The hold-up power supply system comprises: an isolation transformer element, connected to the power factor correction unit, for receiving and transforming a first power to a third power; a power storage element, for receiving the third power, comprising a power storage element storing a hold-up power; and a power comparison unit, connected between the power factor correction unit and the power storage element. The power comparison unit compares a second power generated from phase modulation performed by the power factor correction unit and the hold-up power, and outputs the hold-up power when the second power is smaller than the hold-up power, so as to sustain the power modulation unit to continue operating for a hold-up time. With the above circuit architecture, issues of a slow booting process and an increased load of the power system derived by an intention of increasing the hold-up time as in a conventional power supply are solved.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply for prolonging a hold-up time, comprising:
a main power supply system, comprising:
a rectification unit, for receiving and rectifying an external power source to output a first power;
a power factor correction unit, for receiving the first power and modulating a phase of the first power to generate a second power;
a voltage stabilization element, for receiving and stabilizing the second power; and
a power modulation unit, connected to the voltage stabilization element, for converting the second power to output an operating power; wherein, the power factor correction unit has an input end connected to the rectification unit and an output end connected to the voltage stabilization element; and
a hold-up power supply system, connected in parallel to the power factor correction unit, comprising:
an isolation transformer element, connected to the input end, for transforming the first power to a third power;
a power storage element, for receiving the third power and storing as a hold-up power; and
a power comparison unit, disposed between the output end and the power storage element to receive the second power and the hold-up power respectively; the power comparison unit comprising a first status for rendering the power storage element to be continuously charged when the second power is greater than the hold-up power, a second status for rendering the power storage element to be no longer charged when the second power is equal to the hold-up power, and a third status for prompting the power storage element to output the hold-up power to the power modulation unit to continue converting the operating power for a hold-up time when the second power is smaller than the hold-up power.

2. The power supply of claim 1, wherein the hold-up power supply system comprises a charging control unit for controlling a conduction status of the isolation transformer element.

3. The power supply of claim 2, wherein the charging control unit comprises a power switch element, and a driving control unit for controlling a conduction status of the power switch element.

4. The power supply of claim 1, wherein the hold-up power supply system comprises a current limiting resistor connected to the isolation transformer element.

5. The power supply of claim 1, wherein the hold-up power supply system comprises a one-directional conduction element connected between the isolation transformer element and the power storage element to restrain a current direction to conduct towards the power storage element.

6. The power supply of claim 5, wherein the one-directional conduction element is a diode.

7. The power supply of claim 1, wherein the power storage element is a group selected from a battery element or a capacitor.

8. The power supply of claim 1, wherein the power comparison unit is a diode.
